(19) United States
(12) Patent Application Publication
(10) Pub. No.: US 2008/0195727 A1
(43) Pub. Date: Aug. 14, 2008

(54) Method And Apparatus For Effecting Telecommunications And Multimedia Communications Over Communications Networks In General And, In Particular, Over The Internet, Using Advanced Communications Terminals

(75) Inventor: Giuseppe Diomelli, Lari (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: C.D.C. S.r.1, Fornacette di Calcinala (Pisa) (IT)

(21) Appl. No.: 11/571,685

(22) PCT Filed: Jul. 6, 2004
(86) PCT No.: PCT/IB2004/002262

§ 371 Date: Feb. 18, 2008

(51) Int. Cl. G06F 15/173

(52) U.S. Cl. 709/224

(57) ABSTRACT

A method for immediately effecting telephone and multimedia communications over the broadband Internet network that comprehensively supports digitalized telephone communications, multimedia communications and electronic data transmissions, through the use of specific Communications Terminals capable of automatically connecting to said Internet network quite like normal POTS telephone devices connect to the traditional PSTN network. A Central Processor also connected to the Internet, is dedicated to supporting said specific Communications Terminals in the aforesaid connection and to interfacing with other similar Terminals. The Central Processor also supports PC or PDA based communications terminals. The Central Processor includes, in particular, a memory section in which the historical data pertaining to the communications made using the supported Terminals, are stored. The above Terminals can connect, automatically or manually, also to wired and wireless communications networks in general, such as, for instance, the PSTN, ISDN, GSM, UMTS or other networks.

### TECHNICAL SECTOR

This invention refers to a method and related apparatus enabling telecommunications and multimedia communications to be effected through Advanced Communications Terminals, over Internet computer networks capable of supporting, in an integrated manner, telephone communications, multimedia communications, and electronic data transmissions.

The invention also refers to terminals able to effect telecommunications and multimedia communications, especially over Internet computer networks.

### STATE OF THE ART

The use of telephony and video telephony over the Internet network through devices and personal computers directly connected to the said network, is becoming increasingly widespread. Thanks to the growing penetration of personal computers and technologies providing for broadband Internet connections in homes and offices, it is now possible to use the Internet network to transfer data pertaining to the digitalization of voice and video communications.

In such regard, specific methods and technologies have been developed for the transmission and management of the data pertaining to the digitalization of voice, video and multimedia communications.

Patent no. P12002A000026, held by the same applicant, contains a description of a method and related apparatuses for the management of telephone communications, using local area networks (LANs) capable of supporting both data transmissions and telephone communications.

A later patent, no. PI2003A000101, also held by the same applicant, contains the description of a method and related apparatus for the unified management of overall communications such as: telephone calls, facsimile transmissions, SMS and MMS, video, e-mail, chat and multimedia communications in general, that facilitates the interfacing of the various communications and telecommunications networks and their related transmission protocols.

In all cases, telephone and multimedia communications are effected over Internet type computer networks, using personal computers endowed with audio or audiovisual means or through PC terminals, known as IP Telephones or Internet Phones. Both these devices are connected to the so-called Internet networks through specific devices known as Modems, with or without a router, that basically manage the online identification of the devices in question. This can however occur only after the devices involved in the communication, including the routers, have been set and configured by a skilled technician.

It is obvious that for many users, devoid of specific networking or computer knowledge, it is very difficult, if not completely impossible, to use a communications terminal that must be connected to the Internet network, such as, for instance an IP PHONE, that always requires specific settings and/or data to be input through a personal computer, to be able to function properly.

In other words, to date, it is not possible to link a Communications Terminal, such as an IP PHONE to the broadband Internet or DSL network, with the same ease as one could connect a POTS Communications Terminal, that is to say a common telephone, to the public wired telecommunications network (PSTN).

The meaning of the acronyms and specific technical terms used herein in Italian or English, is provided under the headings ACRONYMS and GLOSSARY at the end of the descriptive portion of this patent application.

### SUMMARY OF THE INVENTION

The main object of this invention is to propose a method, and related apparatus, allowing for the use of Communications Terminals to transmit and receive, data, voice, video and multimedia communications over the broadband Internet network, without the need for setting or configuring said Terminals in any way.

Another object of the invention is propose a method that allows IP Communications Terminals to be used just like one would use a common telephone or videotelephone, in order to communicate with other users endowed with similar Communications Terminals.

A further purpose of the invention is to propose a method and related apparatus allowing for the use of IP Communications Terminals with both the Internet network and the PSTN or ISDN networks, through automatic or manual switching between said networks.

The invention moreover aims to propose a method and related apparatus allowing for the use of specific Communications Terminals with both the Internet network and the PSTN or ISDN networks, even simultaneously, so as to allow for multiple communications addressed to one or more of the said Communications Terminal.

A still further purpose of the invention is to propose specific Communications Terminals for the transmission and reception of data, voice, video and multimedia communications over the broadband Internet network, said Terminals being activated and used in the same way as one would activate and use a common telephone or videotelephone.

Another purpose of the invention is to propose specific Communications Terminals that are capable of displaying a series of information pertaining to the Communications Terminal called, according to criteria set by the caller, such as: preferential telephone number, name and surname, address, sex, profession, the status of the Communications Terminal or other data that may be displayed to the caller before or during the connection to the recipient of the call.

The aforesaid purposes are fulfilled through a method and related apparatus allowing for telephone and multimedia communications over the Internet computer network capable of comprehensively supporting digitalized telephone communications, multimedia communications and electronic data transmissions, wherein said communications are effected through Advanced Communications Terminals that include means of connection to said broadband Internet network, and that are characterised by the fact that the connection to the broadband Internet network is ensured from the very first connection, and is automatically maintained over time. The aforesaid Advanced Communications Terminals also contain means for digitalization which allow for the transmission, reception and control of voice, video and multimedia data, as well as for detecting the status of said Communications Terminals.

The aforesaid Terminals include means for sending, at pre-set intervals, data packets pertaining to the identification number and the status of the Terminal itself, to a Central Processor or Server that is part of the apparatus of the invention and linked to the Internet network, and that has already been input, manually or automatically, with the identification numbers of the Advanced Communications Terminals connected to said network as well as with the programmes and procedures required for detecting the status of each of said Communications Terminals.

The method of the invention therefore requires the use of:
Advanced Communications Terminals linked to the broadband Internet network, and
A Central Processor or Server, also linked to said Internet network.

The method further requires the use of Communications Terminals based on Personal Computers (PCs) or Personal Digital Assistants (PDAs) that are linked to the broadband Internet Network, and that meet all the requirements of the aforesaid Advanced Communications Terminals and may therefore be suitably identified and recognized by a Central Processor or Server also linked to said Internet Network. Both, the Advanced Communications Terminals and the Communications Terminals based on PCs or PDAs, include:
means dedicated to recognizing the broadband Internet (DSL) network and to establishing an automatic connection to said network;
means dedicated to monitoring the connection to the broadband Internet (DSL) network and to automatic re-connecting in case the connection is cut off;
means for sending over the Internet, the identification data and status of the Terminal in question;
means for the digitalization, management and control of voice, video, data and multimedia communications;
means for the management and control of communications over the wired Public Telecommunications Network (PSTN or ISDN);
means for automatically or manually switching in order to obtain the automatic or manual transfer of the call from the Internet network to the wired Public Telecommunications Network (PSTN or ISDN);
means for sending multiple messages simultaneously.

The Central Processor or Server, that is part of the apparatus of the invention and is linked to the Internet network, includes:
sections for interfacing with the Internet network;
sections for detecting the status of each Advanced Communications Terminal connected to the Internet network;
sections for storing in memory the identification numbers of the Advanced Communications Terminals connected to the Internet network;
sections for storing in memory one or more numbers belonging to groups of wired or wireless telephone numbers selected by the users of each Advanced Communications Terminal;
sections for storing in memory number pairs for each of the Advanced Communications Terminals;
sections for storing in memory the personal data of the users of Communications Terminals, said data being associated with the aforesaid number pairs;
sections for the archiving of data pertaining to communications via the Internet between Advanced Communications Terminals;
computer programmes that allow for the recognition of and connection to the Internet Network as well as the management of the data exchanges required for effecting telephone and/or videophone and/or multimedia communications using the Advanced Communications Terminals over the broadband Internet Network.

Upon connection of a Communications Terminal to the Internet network, the sections of said Terminal dedicated to recognizing the type of broadband network, such as, for instance, ADSL, HDSL, etc., and the Internet service provider, such as, for instance, Deutsche Telekom, British Telecom, France Télécom, etc., enable access to said network and cause each Communications Terminal to send to the Central Processor or Server connected to the Internet network, digitalized information allowing for the storage in the Central Processor's memory, of both, the identification number of each Communications Terminal as well as the status thereof, such as, “on, on but busy, off, etc.” All the Communications Terminals that are switched on are connected through the Internet network to the Central Processor or Server that is part of the apparatus of the invention.

Each Communications Terminal is equipped with a keyboard through which the user sends to the Central Processor or Server, one or more telephone numbers selected by the user. Accordingly, each Communications Terminal identification number is matched with one or more numbers selected by the user of the Communications Terminal in such manner that the pairs or series of numbers for each of the online Terminals are stored in the Central Processor's or Server's memory.

With the method and apparatus of the invention, all problems are eliminated for first-time users of an Advanced Communications Terminal as claimed in the invention, thereby reaching the goal of making said Communications Terminal as easy to use as a common analogue telephone (POTS).

### BRIEF DESCRIPTION OF THE DRAWINGS

To better understand the features and benefits of the invention and the substantial difference between the invention and systems currently in use, we shall refer to a practical embodiment of the same, using the attached drawing, in which:

FIG. 1 represents a schematic block diagram of an example of the interconnection of apparatuses according to the invention, to computer and telecommunications networks.

### DESCRIPTION OF PREFERRED EMBODIMENTS

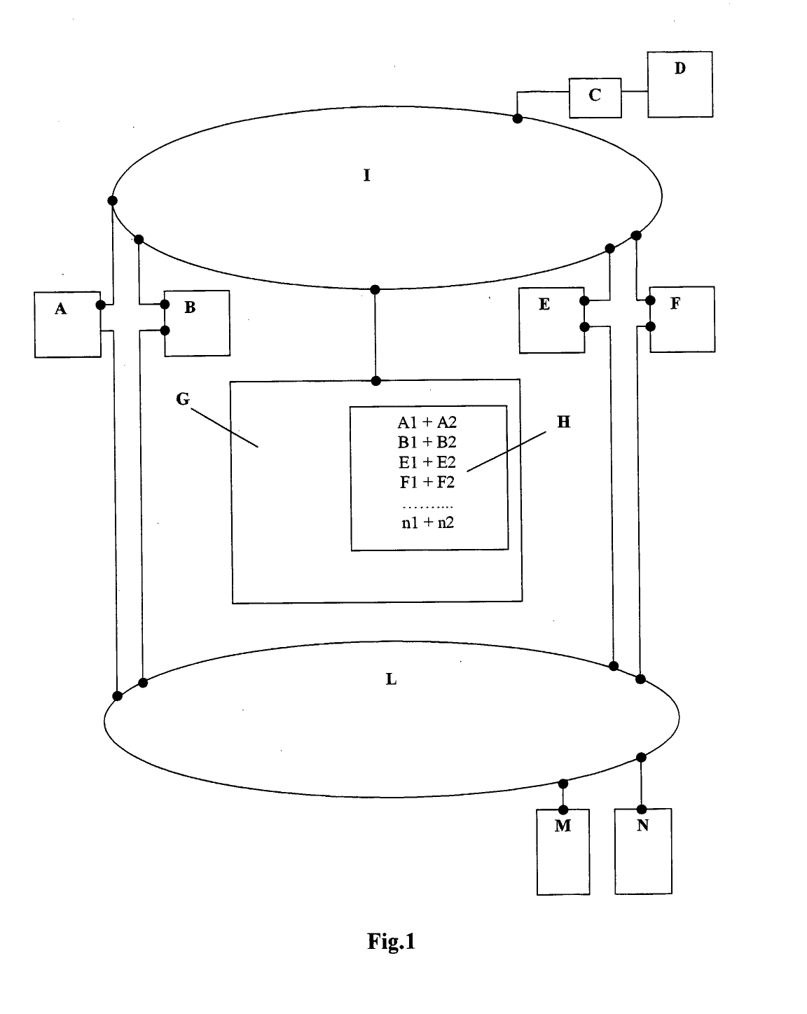

Advanced Communications Terminals according to the invention, that are suitable for effecting telephone and/or videophone and/or multimedia communications both over the Internet networks and over the public PSTN or ISDN telecommunications networks, are shown in FIG. 1, under letters A, B, E, F.

The above Terminals (A, B, E, F) are directly or indirectly connected to both, the Internet network (I) and the public PSTN or ISDN telecommunications network (L) to which the POTS analogue Communications Terminals or common telephones (M, N) are also connected.

Common PCs (D) are connected to said Internet network through suitable modems (C).

FIG. 1 also shows the diagram of a Central Processor or Server (G) including sections for interfacing with the Internet network (I), sections for recognizing and detecting the status of each Advanced Communications Terminal (A, B, E, F) connected to the Internet network (I), memory sections (H) for the storage of the identification numbers (A1, B1, E1, F1 . . . n1) of the Advanced Communications Terminals (A, B, E, F), memory sections (H) for the storage of the individual numbers (A2, B2, E2, F2, . . . n2) belonging to the users of the Advanced Communications Terminals, memory sections (H) for the storage of number pairs (A1+A2, B1+B2, E1+E2, F1+F2, . . . n1+n2), memory sections for the storage of the personal data of each user, sections allowing for connections between the Advanced Communications Terminals (A, B, E, F) and managing the data exchanges required to enable telephone and/or videophone and/or multimedia communications over Internet networks (I), sections for archiving data pertaining to communications via the Internet (I) between the aforesaid Advanced Communications Terminals.

The Advanced Communications Terminals (A, B, E, F), covered under the invention, automatically provide for wired or wireless connection to the broadband Internet Network (I). The connection is made possible, starting from the very first physical connection made (link-up), thanks to specific means that automatically interact with the various Internet Connectivity Providers, without the need for any action whatsoever by the user.

The Advanced Communications Terminals (A, B, E, F) may obviously be situated at very remote locations. Once connected to the Internet network (I), they automatically send at pre-set intervals their identification number (A1, B1, E1, F1) signalling that they are online to a Central Processor (G) that is also connected to the Internet network (I) and that comprises memory sections (H) dedicated to storing said identification numbers (A1, B1, E1, F1).

Furthermore, the memory sections (H) of said Central Processor (G) have already been input with the personal data as well as one or more numbers selected by the user of each Advanced Communications Terminal (A, B, E, F), or belonging to a group of wired or wireless telephone numbers already in use by the user; these numbers may be defined as “individual” in the sense that each number stored in memory is different from all the other numbers already stored or storable in memory. Therefore, the memory sections (H) of the Central Processor or Server (G) connected to the Internet Network, store a database corresponding to number pairs (A1+A2, B1+B2, C1+C2, . . . , n1+n2) unequivocally attributed to each Advanced Communications Terminal (A, B, E, F).

After a wired or wireless connection is established between the Communications Terminal (A) and the broadband Internet network (I), a signal on the screen indicates that the connection has been secured and that the Central Processor (G) has recognized the Communications Terminal (A) as being “on”, insofar as said Terminal periodically sends its identification number (A1) as well as other signals indicating its status, such as “on, busy, off, etc.” to the Central Processor (G) over the Internet. The Communications Terminal (A) receives signals confirming the connection from the Central Processor.

The same operations effected from the Communications Terminal (A) are carried out, even for Communications Terminal (F); the Central Processor (G) recognizes the latter upon receiving identification number (F1) of the Terminal that in turn receives signals confirming the connection, from the Central Processor.

To effect a telephone, videophone or multimedia communication from the Communications Terminal (A) to the Communications Terminal (F) both of which are connected to the Internet, the Communications Terminal (A) must provide the Central Processor (G) with a numeric sequence (F2) either by dialing the sequence or recovering the same from the memory of the Communications Terminal or the Central Processor (G), following which the Central Processor (G) will recover from the database (H) a number pair including said number (F2) pertaining to the Terminal (F) to which the communication is addressed.

If the number pair (F1+F2) exists in the database (H), a specific software programme of the Central Processor (G) will also check the information regarding the status of the Communications Terminal (F) to which the communication is addressed, in terms of “on, on but busy, off, etc.” such status being periodically communicated to the said Central Processor (G) by the Communications Terminal (F).

In case the Communications Terminal (F) called by the Communications Terminal (A) is in a status of “on,” and “not busy”, the Central Processor (G) will enable the connection over the broadband Internet network, so as to allow a flow of data packets between the Terminals (A) and (F), using the IP protocol over the Internet.

It must be pointed out that following the call from the Communications Terminal (A) to the Communications Terminal (F), the following situations are possible:
“Terminal Ringing” when the called Terminal (F) is on and not busy.
“Terminal Busy” when the called Terminal (F) is on but engaged in another communication;
“Unknown Number” when the number pair (F1+F2) is not stored in the database (H) either because the Terminal (F) has never been activated or because the number (F2) has not yet been associated with the Terminal's identification number (F1). Before the call is made, the display panels of the advanced Communications Terminals (A, B, E, F), can automatically display the information that the users of each Terminal have pre set into the memory sections (H) of the Central Processor or Server (G), such as, for instance, information pertaining to: the telephone number selected, name and surname, address, sex, profession, status of the Advanced Communications Terminal, etc, thus allowing the caller's Communications Terminal to access the information of the Communications Terminal to which the communication is addressed, even before the connection is established.

All calls can be traced using the data associated with both the caller's number and number called, as stored in the database of the Central Processor and each call generates a call signal (ringing tone) in the Communications Terminals of both the caller and party called, provided that such Communications Terminals are switched on; the ringing tones are identical to those generated by common telephone and videophone calls in standard communications terminals used for analogue PSTN (L) or digital ISDN lines.

The Advanced Communications Terminals (A, B, E, F) can also connect manually or automatically to the PSTN (L) line, in case the Internet connection or IP Phone call is cut off or where the quality of the communication in question, is unacceptable. In such cases, the telephone number is automatically dialed to place a standard call over the PSTN network from Terminal (A) to Terminal (F).

Obviously, the connection to the PSTN network (L) is used also to communicate with any and all analogue terminals (M, N) that are not connected to the Internet and that can therefore be reached only through the PSTN network.

The foregoing considerations clearly illustrate the advantages provided by the method and apparatus of the invention for the management of communications effected using the Advanced Communications Terminals (A, B, E, F) that may be used in any and all locations from where the Internet network can be accessed, after automatically establishing a simple, even wireless, connection to the broadband Internet network, such as a DSL connection in general.

The user of an Advanced Communications Terminal as claimed in the invention may therefore place a telephone call via the Internet to a user of an analogue Communications Terminal or even a user of devices based on PCs (D) or PDAs connected to the Internet network, that are enabled to support the method of the invention and are therefore recognized by the Central Processor (G).

The invention therefore provides for the activation, reception, control and management of communications as well as for the archiving of historical data pertaining to said communications. Thanks to the increasingly widespread penetration of broadband in homes and offices throughout the world, each individual user will be able to enjoy greater access to the potential capabilities of the apparatus of the invention, using means of interaction such as the Advanced Communications Terminals (A, B, E, F).

The invention may obviously be subject to changes and variants without in any way falling outside the scope of the protection of the innovative idea, as defined in the claims set forth herein below.

### ACRONYMS

ADSL—Asymmetric Digital Subscriber Loop; BRI—Basic Rate Interface; DSL—Digital Subscriber Loop, GPRS—General Packet Radio Service; GSM—Global System for Mobile Communications; HDSL—High-speed Digital Subscriber Loop; HTTP—HyperText Transfer Protocol; ISDN—Integrated Services Digital Network; ISP—Internet Service Provider; POTS—Plain Old Telephone Service; SIP—Session Initiation Protocol; UMTS—Universal Mobile Telecommunications System;

### GLOSSARY

ANALOGUE PHONE or ANALOGUE TELEPHONE—Common voice communications terminal (POTS) operating on the public fixed telecommunications network PSTN.

CHAT—“Conversation” using interactive video text in real time, between several people over the internet or other electronic networks.

CLIENT—Term indicating a PC or other communications terminal connected to a Central Processor or Network Server through a LAN, WAN or the Internet.

CIRCUIT SWITCHING—Technique used in communications networks in which a physical connection is set up, maintained and terminated for each communications session.

COMMUNICATIONS STANDARDS—Universally adopted rules, protocols and operating procedures, defined by international organisations and used in various communications infrastructure such as telecommunications networks, electronic networks, network devices, and communications devices and terminals in general.

COMMUNICATIONS PROTOCOL—Set of shared rules designed for standardising activities aimed at transferring or managing information. Examples include: H323, SIP, MEGACO, RTP, POTS, ISDN BRI, ISDN PRI, GSM, UMTS, T38, V27, HTTP, XML, IMAP, SMTP.

COMMUNICATIONS TERMINAL—Device capable of locally managing the type of communication for which it is enabled. For example, the telephone manages phone communications, the modem manages data transmission, the fax machine allows for the transmission of fixed images, etc.

CTI—Central Processor Telephony Integration: technology that integrates the communications functions of the telephone with data processing functions of the computer, making way for full interaction between the two types of devices.

DATABASE—Set of data linked by precise relations and grouped in a structured manner (records and fields). Databases are generally hosted on network servers and can be easily consulted through interrogations from PCs or DEVICES belonging to the same network or linked to the said network.

DEVICE—General term used to indicate the individual components of a system, even online. For instance: desktop computers, palmtop computers, intelligent terminals, printers, etc.

ETHERNET—The most widespread technology used by Local Area Networks (LANs).

FAX—System that allows for the transmission of pages (in the form of images) using a telephone line.

FILE—Data stored in digital form on a storage medium (hard drive, floppy disks, CDs, etc.).

INTERNET PHONE (IP PHONE)—Communications device or terminal equipped with an interface and internal functions for forwarding and receiving telephone calls through the LAN, WAN or Internet network to which it is connected.

IP—Internet Protocol. The Level 3 protocol on which the Internet is based.

LAN—Local area network. Central Processor network that connects two or more computers and/or peripheral devices (for instance, printers, fax machines, scanners) within a rather limited area (local network) for the purpose of communicating and sharing files and data.

MMS—Multimedia Messaging Service—Multimedia messaging service that allows for the creation of messages containing a combination of text, images, sound, melodies and film clips.

MOBILE NETWORK—Mobile telecommunications network

PDA—Personal Digital Assistant—A palmtop computer, an electronic diary or planner or any small digital device designed for personal use. The term has recently assumed a wider meaning to indicate all those mobile terminals devoid of telephone functions.

PSTN—Public Switched Telephone Network. Telecommunications network with analogue access. The normal telephone network for voice transmission.

ROUTER—Device for the interconnection and routing of data packets between computer networks.

SERVER—A set made up of an electronic processor and a software programme that offers services to clients (PCs or Devices in general) such as the storage of files (file server), programmes (applications server), the sharing of printers (print server), fax machines (fax server), modems (modem server), etc.

SMS—Short Message Service—designed for sending or receiving messages of no more than 160 characters using cell phones that support this function.

VoIP—Voice over IP. This term denotes the set of functions and architectures that allow for voice communications over networks with packet switching Technique, also ensuring interoperability with pre-existing telecommunications networks (PSTN, ISDN).

WORLD WIDE WEB (WWW) also known as the WEB—Set of hypertext servers accessible over the Internet to Clients using Web Browsers that provides access to a single global information system.

XDSL—X Digital Subscriber Loop—This abbreviation indicates various broadband transmission technologies on the last copper tract of the Telecommunications Network (ex.: ADSL, HDSL, VDSL, etc.)

### LEGEND TO FIG. 1

A: Advanced communications terminal that is a subject-matter of the invention, capable of effecting telephone and/or videophone and/or multimedia communications over Internet (IP) networks and over PSTN or ISDN networks.
B: Advanced communications terminal that is the subject-matter of the invention, capable of effecting telephone and/or videophone and/or multimedia communications over Internet (IP) networks and over PSTN or ISDN networks.
C: Means of connection to the broadband Internet network (DSL) such as a DSL MODEM
D: Personal computer (PC) connected to the broadband Internet network via a DSL modem.
E: Advanced communications terminal that is a subject-matter of the invention, capable of effecting telephone and/or videophone and/or multimedia communications over Internet (IP) networks and over PSTN or ISDN networks.
F: Advanced communications terminal that is the subject-matter of the invention, capable of effecting telephone and/or videophone and/or multimedia communications over Internet (IP) networks and over PSTN or ISDN networks.
G: Central processor or Network Server connected to the Internet.
H: Memory unit of the central processor or Network Server in which the database of the numbers of the communications grouping is stored. The numbers are paired as follows:
   A1: Identification number of the Communications Terminal A.
   A2: An individual number or a number belonging to a group of wired or wireless telephone numbers already used by the user of Communications Terminal A.
   A1+A2: Number pair attributed unequivocally to the same Communications Terminal, made up of the identification number of the Communications Terminal and the individual number or numbers belonging to a group of wired or wireless telephone numbers already used by the user of said Terminal.
   A1+A2, B1+B2, C1+C2, . . . , n1+n2: DATABASE made up of the number pairs attributed to each Communications Terminal A, B, C, D, E, F, G.
I: Broadband Internet network.
L: Wired Public Telecommunications network PSTN or ISDN for connecting analogue communications terminals (POTS).
M: Analogue Communications Terminal (POTS) or common telephone device.
N: Analogue Communications Terminal (POTS) or common telephone device.

1. Method for initiating, receiving, controlling and managing all types of communications including telephone calls via the broadband Internet network (I), telephone calls via PSTN (L), SMS and/or MMS messages, video communications, e-mail messages, chat, and multimedia communications in general, comprising the steps of:
providing Advanced communication Terminals (A, B, E, F) including means dedicated to recognizing the broadband Internet (DSL) network and to establishing an automatic connection to said network, means dedicated to monitoring the ongoing connection to the broadband Internet (DSL) network and to automatically re-connecting in case where the connection is cut off, means for digitalisation, transmission, reception and control of data pertaining to voice, video and multimedia communications, means for transmitting the status of the Advanced Communications Terminal itself, and means for automatically or manually switching in order to obtain the automatic or manual transfer of the call from the Broadband Internet network (I) to the wired Public Telecommunications Network (PSTN or ISDN) (L);
providing at least one Central Processor or server (G) connected to the Broadband Internet network (I), including sections for interfacing with the Broadband Internet network (I), sections for detecting the status of each Advanced Communications Terminal (A, B, E, F) connected to the Broadband Internet network (I), and sections for storing the identification number of the Advanced Communications Terminals (A, B, E, F) connected to the Broadband Internet network (I); and
enabling all the inbound and outbound communications made through said Advanced Communications Terminals (A, B, E, F), either individually or in multiple communications mode, even mixing different types of all said communications.

2. Method as claimed in claim 1, further comprising the steps of:
automatically establishing, by said Advanced Communications Terminals (A, B, E, F), said connection to the broadband Internet (DSL) network, starting from the very first attempt, (link-up); and
automatically maintaining said connection over time.

3. Method as claimed in claim 1, further comprising the steps of:
transmitting, by said Advanced Communications Terminals (A, B, E, F), at pre-set intervals, data packets pertaining to their identification number (A1, B1, E1, F1, . . . n1) and their status to said Central Processor or Server (G);
checking, by said Central Processor or Server (G), whether or not said identification number is stored in a database (H) of said Central Processor or Server (G); and
in an affirmative case, enabling the functioning of said Advanced communications Terminals.

4. Method as claimed in claim 1, further comprising the steps of:
providing, into said Central Processor or Server (G), sections capable of allowing for the pairing of said identification numbers (A1, B1, E1, F1) of each Advanced Communications Terminals (A, B, E, F) with one or more individual numbers selected by the user of each Advanced Communications Terminals (A, B, E, F) or belonging to a group of wired or wireless telephone numbers already in use by said user (A2, B2, E2, F2), in such a manner that said Central Processor (G) contains a DATABASE (H) of number pairs (A1+A2, B1+B2, E1+E2, . . . F1+F2), each of which being associated with each of said Advanced Communications Terminals (A, B, E, F);
transmitting, by Advanced Communications Terminals (A, B, E, F) from which a call is placed, to the Central Processor or Server (G), the individual number or wired or wireless telephone number (A2, B2, E2, F2);
checking, by said Central Processor or Server (G), if said number (A2, B2, E2, F2) is included in one or more of said number pairs (A1+A2, B1+B2, E1+E2, F1+F2, . . . n1+n2) stored into said DATABASE (H); and
in an affirmative case, enabling the communication between said Advanced Communications Terminal and the called number.

5. Method as claimed in claim 4, further comprising the steps of:
enabling, by said Central Processor or Server (G) connected to the Broadband Internet network (I), communications via the Internet (I) between a first Advanced Communications Terminal (A) connected to the Broadband Internet network (I) and a second Advanced Communications Terminal (F) connected to the Broadband Internet network (I), when:
both said Advanced Communications Terminals are recognized by the Central Processor or Server (G) connected to the Broadband Internet network (I) as being switched on;
the DATABASE (H) contains the number pairs (A1+A2, F1+F2); and
one (A) of said Advanced Communications Terminals sends to the Central Processor or Server (G) the individual wired or wireless telephone number (F2) that is part of one or more of said pairs stored into said DATABASE (H).

6. Method as claimed in claim 5 wherein communications over the Internet are enabled between more than two Advanced Communications Terminals (A, B, E, F) connected to the Broadband Internet network (I).

7. Method as claimed in claim 1, further comprising the steps of:
providing Advanced Communications Terminals (A, B, E, F) including means for displaying the information received, made public by all the users of said Advanced Communications Terminals;
storing such information in memory sections (H) of said Central Processor (G); and
associating the above information with the number pairs (A1+A2, B1+B2, E1+E2, F1+F2, . . . n1+n2) including, the individual number or telephone number selected (A2, B2, E2, F2, . . . n2), name and surname, address, sex, and profession of the user, status of the Advanced Communications Terminals, or others.

8. Method as claimed in claim 1, further comprising the steps of:
providing Advanced Communications Terminals (A, B, E, F) including means for simultaneously displaying a desired selection of information received, made public by a desired list of users of the Advanced Communications Terminals;
storing such information in memory sections (H) of the Central Processor (G); and
associating the above information with the number pairs (A1+A2, B1+B2, E1+E2, F1+F2, . . . n1+n2) including, the individual number or telephone number selected (A2, B2, E2, F2, . . . n2), name and surname, address, sex, and profession of the user, status of the Advanced Communications Terminals, or others.

9. Method as claimed in claim 1, further comprising the steps of:
automatically detecting and selecting, by said Advanced Communications Terminals, the Broadband Internet network (I) instead of the PSTN or ISDN network (L), if in correspondence to a call placed from an Advanced Communications Terminal (A) with a status of “on” and connected to the Broadband Internet network (I), dialing the number (F1) of an Advanced Communications Terminal (F) with a status “on” and connected to the Broadband Internet network (I), there is in said DATABASE (H) a number pair (F1+F2) that includes said individual number (F2).

10. Method as claimed in claim 1, further comprising the steps of:
automatically detecting and selecting, by said Advanced Communications Terminals, the PSTN or ISDN network (L), instead of the Broadband Internet network (I), in the case where:
for calls placed from an Advanced Communications Terminal (A) with a status of “on” and connected to the Broadband Internet network (I) and to the PSTN or ISDN network, to a second Advanced Communications Terminal (F) by dialing the number of the latter (F1), the status of said second Advanced Communications Terminal is not “on”, or
when the quality of communications over the Internet is below a required standard.

11. Method as claimed in claim 1, further comprising the steps of:
allowing, by said Advanced Communications Terminals, for the simultaneous manual selection of the PSTN or ISDN network (L) and the Broadband Internet network (I), in the case where:
for calls placed from an Advanced Communications Terminal (A) with a status of “on” and connected to the Broadband Internet network (I) and to the PSTN or ISDN network, to a second Advanced Communications Terminal (F) by dialing the number of the latter (F1), the status of said second Advanced Communications Terminal is not “on”, or
the quality of communications over the Internet is below a required standard.

12. Method as claimed in claim 1, further comprising the steps of:
allowing for manual dialing, from one Advanced Communications Terminals with a status of “on” (A) connected to the Broadband Internet network (I), of several simultaneous calls addressed to Advanced Communications Terminals also with a status of “on” (B, E, F), and connected to the Broadband Internet network (I) so as to obtain a conference call between more than two users.

13. Apparatus for initiating, receiving, controlling and managing all types of communications, including telephone calls via the broadband Internet network (I), telephone calls via PSTN (L), SMS and/or MMS messages, video communications, e-mail messages, chat, and multimedia communications in general, comprising:
Advanced communication Terminals (A, B, E, F) for the transmission, reception and control of data pertaining to voice, video and multimedia communications over the broadband Internet network (I), including:
means dedicated to recognizing the broadband Internet (DSL) network and to establishing an automatic connection;
means dedicated to monitoring the ongoing connection to the broadband Internet (DSL) network and to automatically re-connecting in case where the connection is cut off;
means for digitization, management and control of data of voice, video, data and multimedia communications;
means for management and control of communication over the wired Public Telecommunications Network (PSTN or ISDN) (L);
means for sending multiple messages simultaneously;
Central Processor or Server (G) connected to the broadband Internet network (I), including:
sections for interfacing with the Broadband Internet network (I),
sections for detecting the status of each Advanced Communications Terminal (A, B, E, F) connected to the Broadband Internet network (I),
sections for storing the identification numbers (A1, B1, E1, F1, . . . n1) of the Advanced Communications Terminals connected to the Broadband Internet network (I);
sections for storing one or more numbers belonging to groups of wired or wireless telephone number (A2, B2, E2, F2) selected by the users of said Advanced Communications Terminal;
sections for pairing and storing number pairs (A1+A2, B1+B2, E1+E2, F1+F2, . . . n1+n2) associated with each of said Advanced Communications Terminals;
sections for storing personal data of the users of Communications Terminals, said data being associated with said number pairs;
sections for the archiving of data pertaining to communications via the Internet between Advanced Communications Terminals; and
Central Processor software programs that allow for the recognition of and connection to the Broadband Internet network (I) as well as the management of the data exchange required for the effecting telephone and/or videophone and/or multimedia communications using the Advanced Communications Terminals over the broadband Internet network (I).

14. Apparatus as claimed in claim 13, wherein said Advanced Communications Terminals are based on Personal Computers (PC) or Palmtop Computers (PDA).
